(19) United States
(12) Patent Application Publication
(10) Pub. No.: US 2012/0068132 A1
(43) Pub. Date: Mar. 22, 2012

(54) Manual Marine Winch With Self Releasing Handle

(75) Inventors: David B. Grapes, Pittsburgh, PA (US); Taylor Grapes, Pittsburgh, PA (US)

(73) Assignee: W. W. PATTERSON COMPANY, Pittsburgh, PA (US)

(21) Appl. No.: 13/234,187

(22) Filed: Sep. 16, 2011

Related U.S. Application Data
(60) Provisional application No. 61/384,223, filed on Sep. 17, 2010.

(51) Int. Cl. B66D 1/04; B66D 1/06

(52) U.S. Cl. 254/352

(57) ABSTRACT

A manual marine winch comprising a winch housing, rotating drum assembly supported on the housing, and a manually actuated control for spooling and un-spooling a winch line on the drum, wherein the control includes a self-releasing handle for selectively tensioning the drum. handle includes i) a ratchet gear coupled to the drum ii) a rotating handle body with a manual end grip, iii) a user engaged trigger mechanism moveable between an engaged and release position, and iv) a handle locking pawl on the body coupled to the trigger mechanism and moveable between a position engaged with the gear rotationally securing the body to the gear and drum when the trigger is in the engaged position and a position disengaged with the gear rotationally separating the body from the gear and drum when the trigger is not in the engaged position.

### RELATED APPLICATIONS

This application claims the benefit of U.S. Provisional patent application Ser. No. 61/384,223 filed Sep., 17, 2011, entitled “Manual Marine Winch with Self-Releasing Handle.”

### BACKGROUND OF THE INVENTION

1. Field of the Invention

The present invention relates to manual winches, more particularly, the present invention relates to manual marine winches with self releasing tensioning handles.

2. Background Information

Manual Marine Winches

Winches have been used in many applications. Manual winches have been widely used in barges, tow boats and the like. Typically a manual winch is attached to a boat deck and spools a towing cable on a rotating drum.

Manual winches remain in common use where a powered winch would be impractical or inefficient. Even in a manual winch the operator, through various mechanical advantages, can generate a very large tension on the cable. Examples of manual winches are described in greater detail in U.S. Pat. No. 5,947,450 which is incorporated herein by reference. Examples of manual winches are sold by W. W. Patterson Company, Nabrico and Nashville Bridge Company. The present invention is directed toward a manual winch with a self releasing tensioning handle 100 according to the invention; however a background summary of conventional winch design may be helpful to fully understand the invention.

The conventional prior art manual marine winch 10 is shown in FIG. 16 and includes a base plate 12 and a pair of spaced side plates 14 surrounding a rotatable spool assembly. The rotatable spool assembly is rotationally supported between the side plates 14 and includes a drum 16, a protecting flange 18 on one side of the drum 16 and a controlling gear 20 on the other side of the drum 16. A control assembly 22 is supported by the side plates 14 and engages with the gear 20 to rotate the drum 16 for spooling of a cable (not shown) thereon. The control assembly 22 extends through one side plate 14 and includes a hand wheel 24 and/or an actuating lever or handle 26 which is used for manually operating the winch 10. As will be described in greater detail below the present invention relates to winches incorporating self-releasing handles 100 as described herein. The issues with the prior art handle construction will be discussed after a further introduction to a conventional winch 10.

Returning to the description of the conventional prior art winch 10, a foot brake 28 is attached to the side plate 14 through which the control assembly 22 extends. The foot brake 28 is adapted to frictionally engage the hand wheel 24. A swivel link 30 is attached to the base plate 12 at a rear of the winch 10 and pivotally attaches the winch 10 to a D-ring 32 of a boat deck or the like. A step or foot 34 is attached to the underside of the base plate 12 near a forward portion of the winch 10. A gear guard 36 is attached to one of the side plates 14 on the same side as the gear 20 and is positioned in a cutout formed in the side plate 14. The gear guard 36 prevents the cable from interfering with or becoming wrapped behind the gear 20. Similarly, a flange guard 37 is attached to the other side plate 14 in a cutout formed therein. The flange guard 37 prevents the cable from being wrapped behind the flange 18.

The construction of the manual swivel winch 10 includes the use of four tubular spacers (not shown) for spacing the side plates 14 apart. A bolt 40 extends through the center of each spacer through aligned holes in the opposed side plates 14 and is secured by nuts 42.

In a conventional marine winch a wire rope, the winch line, is spooled back and forth around the rotating drum and the winch line is subject to very large loads. The high loading can cause the outer layers of wire rope to become fouled, jammed or begin binding within the spaces between the lower level wire ropes. Further, rapid tension release in existing wire rope winch systems can result in what is known as “bird-nesting” of the spooled wire rope. This can make unwinding the winch very difficult in subsequent operation, and often requires a second deck hand to assist in the unwinding of the wire rope, or even the engine power of the tow boat. U.S. Pat. No. 7,543,800 which is incorporated herein by reference addressed some of these problems with the design and implementation of a “single stack” winch.

A single stack winch 50 as described in U.S. Pat. No. 7,543,800 is disclosed in FIG. 17 which illustrates a winch 50 that includes a pair of spaced side plates 54 defining an open bottom. A rotating spool assembly is supported between the side plates 54 and includes drum 56 with a protecting flange 58 on one side of the drum 56 and a controlling drum gear 60 on the other side of the drum 56. The construction of the spool assembly is a key feature of the single stack winch 50 design. Adjacent the drum gear 60 is a stacking flange which is spaced from the drum gear 60 a distance sufficient to receive only a single width of winch line. The winch 50 includes stacking area fender 70 as a protective fender and a protective plate 72 with rope access slot 74 further protecting the stacking space and a spacer or support 90.

The U.S. Pat. No. 7,543,800 further notes that the remaining elements of the winch 50 are conventional and known to those in the art. For example the winch includes a hand wheel 76 and lever tension mechanism, also known as a ratchet handle 78 is used to rotate the drum gear 60 through gearing 80 in a conventional fashion. The tension is held on ratchet gears 82 that are engages with pawls 84 with engagement and knockout lever 86, also known in the art. As noted above the present invention is directed to improvements in the ratchet handle of such marine winch designs.

Tensioning Handles

The manual tensioning handles of known marine winches, such as handles 26 and 78 of the winches 10 and 50 of FIGS. 16 and 17, respectively, must be disengaged to allow for unloading or payout of the winch line. If the tension is released on the drum with the handles still accidentally engaged, the handles naturally will rotate, through the gearing, with the drum. In such a case the locking dogs are reengaged until the handles can be disengaged and the process repeated; however with the drum under high loads or tension the accidentally drum-engaged handles can be rotated quite fast or violently before striking the ship's deck. Aside to damaging the handles in this movement, of far greater concern is the potential injury to workers around the winch during such accidental winch handle movement. The danger is only heightened if a handle extension, also called a cheater bar, is left on the handle that is left engaged with the gearing.

It is an object of the present invention to minimize the drawbacks of the existing manual winch handles and to provide a simple easy and safe marine winch handle.

### SUMMARY OF THE INVENTION

The various embodiments and examples of the present invention as presented herein are understood to be illustrative of the present invention and not restrictive thereof and are non-limiting with respect to the scope of the invention.

At least some of the above stated objects are achieved with a manual marine winch that includes a self releasing handle. A manual marine winch according to the invention includes a winch housing, a rotating drum assembly supported on the winch housing, and a manually actuated control for spooling and un-spooling a winch line on the drum, wherein the manually actuated control includes a self-releasing handle for selectively tensioning the drum. The handle includes i) a ratchet gear coupled to the drum wherein rotation of the ratchet gear will cause rotation of the drum, ii) a rotating handle body with a manual end grip, iii) a user engaged trigger mechanism on the end grip moveable between an engaged position and a release position, and iv) a handle locking pawl on the handle body and coupled to the trigger mechanism and moveable between a position engaged with the ratchet gear rotationally securing the handle body to the ratchet gear and the drum in at least one rotational direction when the trigger is in the engaged position and a position disengaged with the ratchet gear rotationally separating the handle body from the ratchet gear and the drum when the trigger is not in the engaged position.

At least some of the above stated objects are a self releasing handle for a manual marine winch and for retrofitting existing marine winches to include the self releasing handle.

In the present invention the handle may include a mechanism biasing the trigger out of the engaged position. The handle locking pawl may be coupled to a pivot pin on the handle body for rotation on the handle body into and out of engagement with the ratchet gear. Further, when the trigger is in the engaged position, the handle locking pawl may be configured to rotationally secure the handle body to the ratchet gear and the drum in one rotational direction and allow ratcheting of the pawl and the ratchet gear in an opposite relative rotational direction. A pawl biasing member may be included and coupled to the handle locking pawl biasing the pawl in one direction. A linkage arm may be provided extending between the trigger mechanism and the handle locking pawl. The trigger mechanism may be coupled to a pivot pin on the handle end grip of the handle body for rotation on the handle body into and out of the engaged position. The handle body may include two spaced side plates extending to the handle end grip. The pawl biasing member may be formed as a spring extending between the pawl and the linkage arm. The mechanism biasing the trigger out of the engaged position is a torsion spring mounted to the end grip.

These and other advantages of the present invention will be clarified in the brief description of the preferred embodiment taken together with the drawings in which like reference numerals represent like elements throughout.

### BRIEF DESCRIPTION OF THE DRAWINGS

FIGS. 1 A and B are perspective views of self-releasing manual marine winch handles in accordance with two embodiments of the present invention with the handles in the engaged drum actuating position;

FIGS. 2 A and B are perspective views of self-releasing manual marine winch handles if FIGS. 1 A and B, respectively with the handles in the released non-drum actuating position;

FIG. 3 is an end view of a self-releasing manual marine winch handle in accordance one embodiment of the present invention;

FIG. 4 is a side elevation view of the self-releasing marine winch handle of FIG. 3;

FIG. 5 is a side sectional view of the self-releasing marine winch handle of FIG. 3;

FIG. 6 is a top plan view of the self-releasing marine winch handle of FIG. 3;

FIGS. 7-9 are side sectional views of the self-releasing marine winch handle of FIG. 3 in the released, engaged and override (or ratchet) positions, respectively;

FIG. 10 is an end view of a self-releasing manual marine winch handle in accordance the other embodiment of the present invention;

FIG. 11 is a side elevation view of the self-releasing marine winch handle of FIG. 10;

FIG. 12 is a side sectional view of the self-releasing marine winch handle of FIG. 10;

FIG. 13 is a top plan view of the self-releasing marine winch handle of FIG. 10;

FIGS. 14-15 are side sectional views of the self-releasing marine winch handle of FIG. 3 in the released and engaged override positions, respectively;

FIG. 16 is a figure of a conventional prior art manual marine winch which can implement a self-releasing marine winch handle according to the present invention;

FIG. 17 is a figure of a single stack manual marine winch which can implement a self-releasing marine winch handle according to the present invention.

### DESCRIPTION OF THE PREFERRED EMBODIMENTS

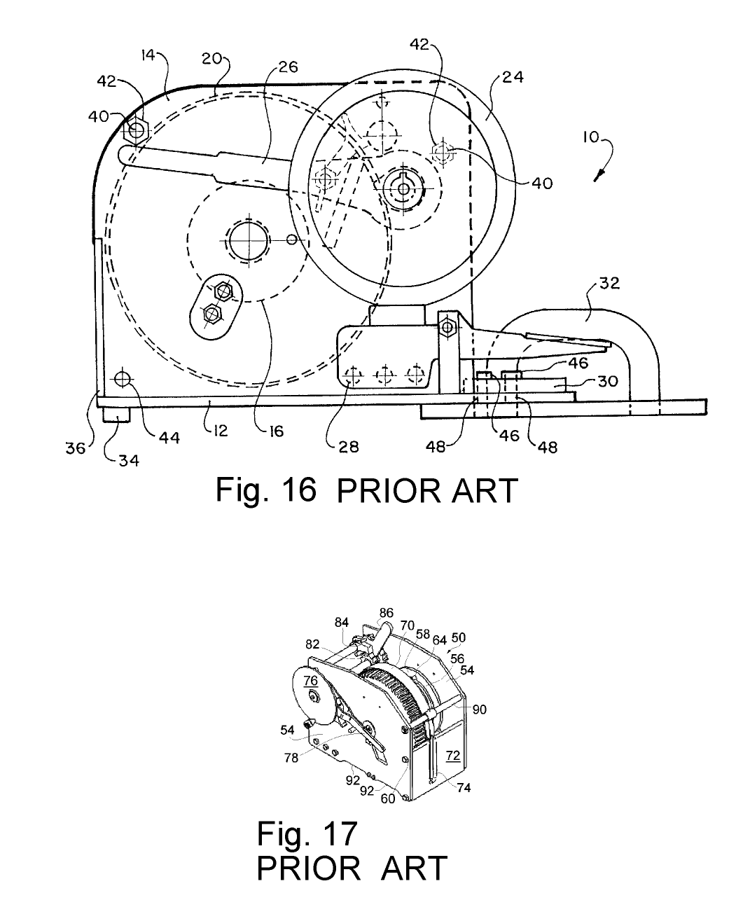

The present invention is directed to a self-releasing handle 100 for a manual marine winch, such as winches 10 and 50 discussed above and shown in FIGS. 16-17, and to a winch incorporating such a handle 100. The handle 100 can be manufactured with the winch, as is conventional, however, it should be apparent that the handle 100 of the present invention can be easily retrofitted into existing winches such as winches 10 and 50 shown in FIGS. 16-17. In a retrofitting operation the old tensioning handle (26 or 78) is merely replaced with the handle 100 of the invention.

The winch of the present invention includes the handle 100 and the remaining conventional components of manual marine winches, such as a winch housing (such as formed by spaced side plate 24 or 54 and associated structure in FIGS. 16 and 17 respectively), a rotating drum assembly (such as formed by spaced elements 16 and 60 and associated structure in FIGS. 16 and 17 respectively) supported on the winch housing, and a manually actuated control for spooling and un-spooling a winch line on the drum. The manually actuated control typically includes pinion gear engaging a drive gear on the drum with a locking dog (ratchet dog) arrangement engaging selective gearing for holding the load under high tension.

The handle 100 of the invention for selectively tensioning the drum is mounted on the drive shaft 104 of the pinion gears of the drum control. The handle 100 includes a ratchet gear 102 keyed or otherwise secured to the drive shaft 104 so as to be coupled to the drum. Through this connection rotation of the ratchet gear 104 will cause rotation of the drum through the pinion gear.

The handle 100 includes two spaced side plates 106 rotationally coupled about the drive shaft 104 and extending to a handle end grip 108. The side plates 106 can each be formed as solid members or as a fabricated structure as shown. The side plates 106 and the end grip 108 combine to form a rotating handle body of the handle 100. The end grip 108 is configured to be easily grasped and manipulated by the user.

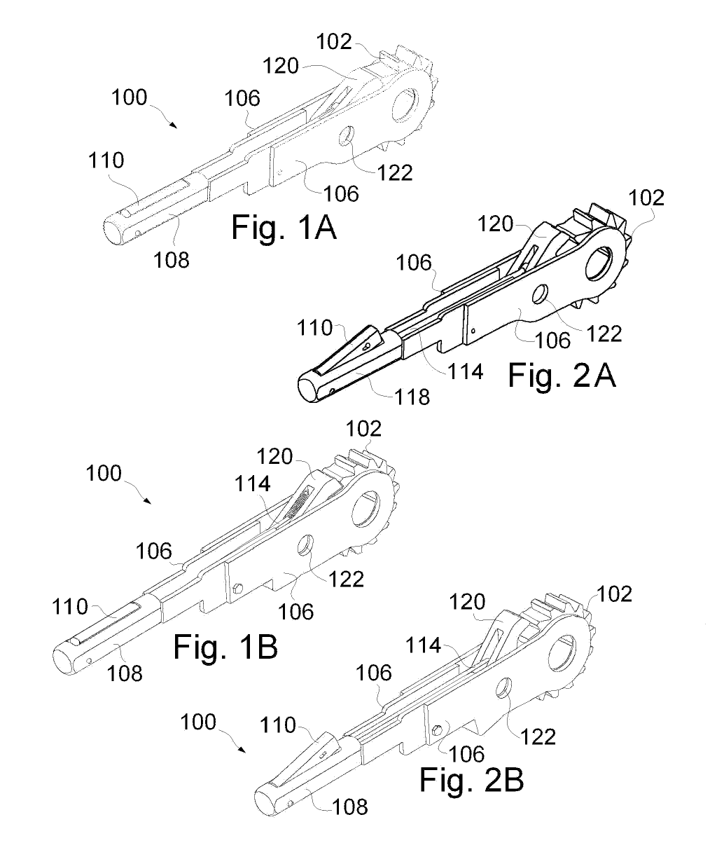

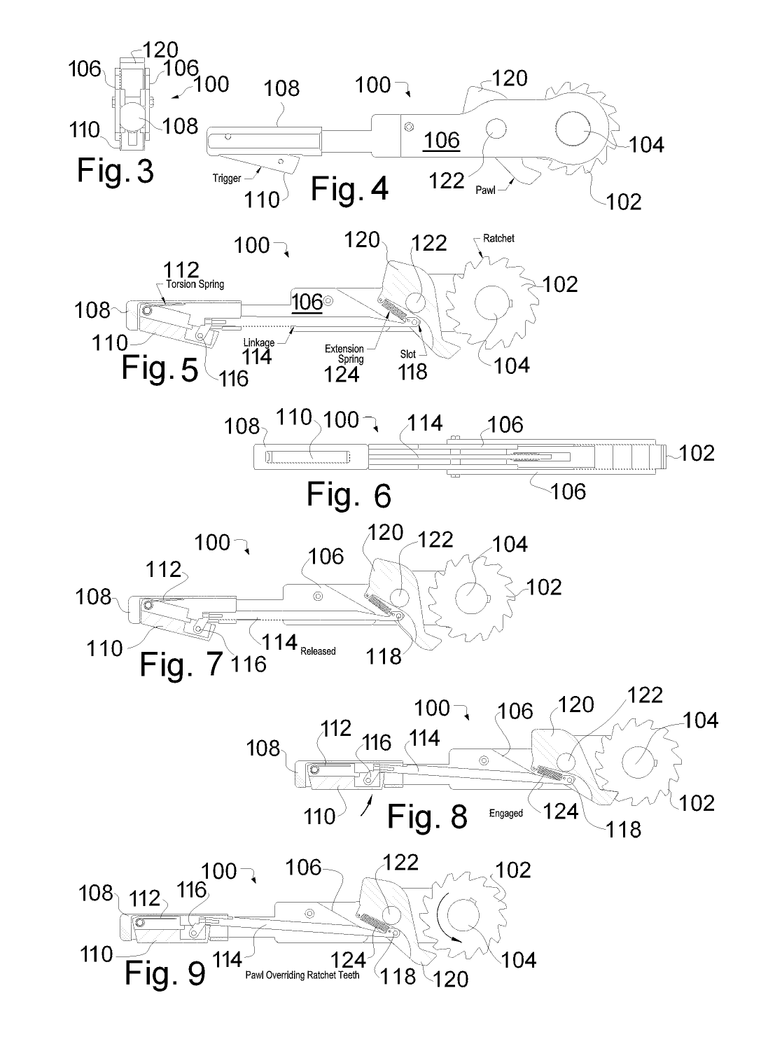

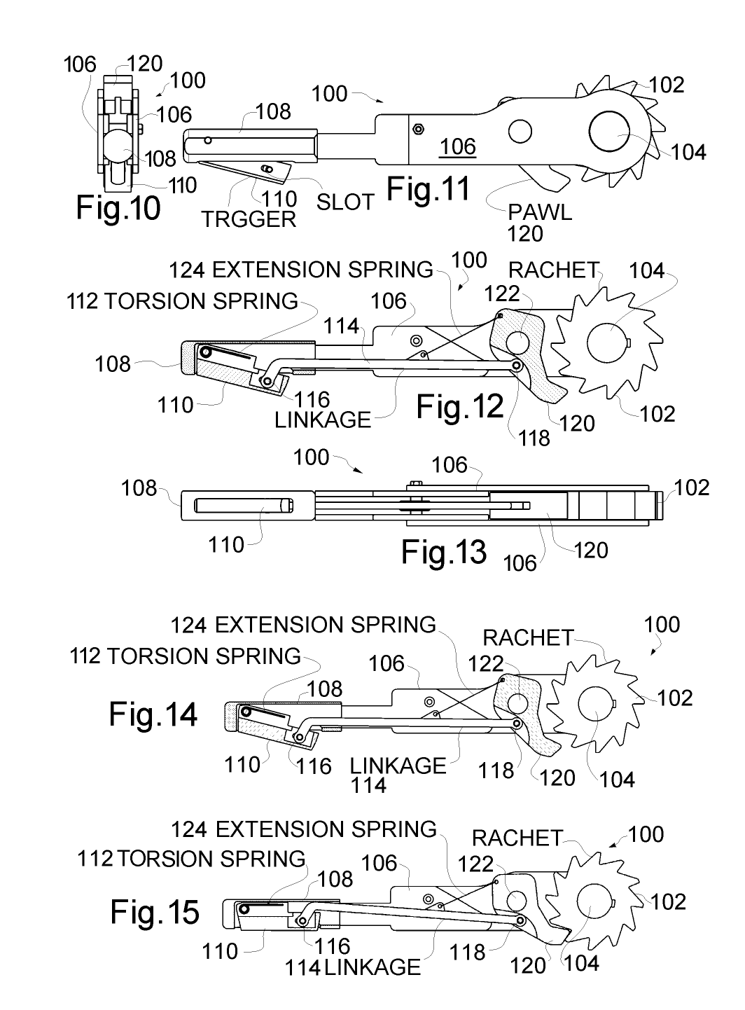

The handle 100 includes a user engaged trigger mechanism 110 on the end grip 112 moveable between an engaged position as shown in FIGS. 1A and B, 8-9 and 15 and a release position shown in the FIGS. 2A and B, 2-7 and 10-14. The trigger mechanism 110 is coupled to a pivot pin on the handle end grip 108 of the handle body for rotation on the handle body into and out of the engaged position. The handle 100 includes a mechanism, namely torsion spring 112, biasing the trigger mechanism 110 out of the engaged position. As the user grasps the handle end grip 108 he will squeeze the trigger mechanism 110 pushing it into the engaged position against the force of the spring 112.

The handle 100 includes a linkage arm 114 extending between the trigger mechanism 112 and a handle locking pawl 120. A first coupling 116 connects the linkage arm 114 to the trigger mechanism 112 and a second connection 118 connects the linkage arm 114 to the locking pawl 120. One of the connections 116 or 118 is formed as a slot to account for the linkage between the pivoting members.

The handle locking pawl 120 is coupled to a pivot pin 122 on the sides 106 of the handle body for rotation on the handle body. With movement of the trigger mechanism 108 into the engaged position, the pawl 120 is moved via the linkage arm 114 into a position engaged with the ratchet gear 102 rotationally securing the handle body to the ratchet gear 102 and the drum in one rotational direction. A pawl biasing member in the form of a spring 124 is coupled to the handle locking pawl 120 and to the linkage arm 114 and acts to bias the pawl 120 in one direction, namely into engagement with the ratchet gear. Thus with the trigger mechanism 110 in the engaged position, the handle locking pawl 120 is configured to rotationally secure the handle body to the ratchet gear 102 and the drum in one rotational direction for tensioning of the drum and allows ratcheting of the pawl 120 and the ratchet gear 102 in an opposite relative rotational direction (generally for resetting the handle 100 for another tensioning turn). In tensioning operations the locking dogs will similarly ratchet against the pinion gear and prevent the pinion gear from turning in the payout direction, which, through the drive shaft 104, holds the ratchet gear 102 from reverse rotation, thus allowing the user to rotate the handle 100 in the opposite direction as shown in FIG. 9 (with the arrow showing relative motion of the gear 102 and the remaining elements of the handle 100). The ratcheting shown in FIG. 9 is also called the “override” position.

Further, when the trigger mechanism 110 is in the disengaged position the pawl 120 is moved to a position disengaged with the ratchet gear 102 rotationally separating the handle body from the ratchet gear 102 and the drum. The trigger mechanism 110 is biased via spring 112 toward the disengaged position. Thus when the user lets go of the grip end 108 and the trigger mechanism 110, the handle 100 releases the connection with the drum, thereby being self releasing.

Although the present invention has been described with particularity herein, the scope of the present invention is not limited to the specific embodiment disclosed. It will be apparent to those of ordinary skill in the art that various modifications may be made to the present invention without departing from the spirit and scope thereof. For example, the location and design of the gearing can be changed for space considerations. The scope of the present invention is defined in the appended claims and equivalents thereto.

What is claimed is:

1. A manual marine winch comprising:
A winch housing
a rotating drum assembly supported on the winch housing; and
a manually actuated control for spooling and un-spooling a winch line on the drum, wherein the manually actuated control includes a self-releasing handle for selectively tensioning the drum including i) a ratchet gear coupled to the drum wherein rotation of the ratchet gear will cause rotation of the drum, ii) a rotating handle body with a manual end grip, iii) a user engaged trigger mechanism on the end grip moveable between an engaged position and a release position, and iv) a handle locking pawl on the handle body and coupled to the trigger mechanism and moveable between a position engaged with the ratchet gear to rotationally secure the handle body to the ratchet gear and the drum in at least one rotational direction when the trigger is in the engaged position and a position disengaged with the ratchet gear rotationally separating the handle body from the ratchet gear and the drum when the trigger is not in the engaged position.

2. The marine winch of claim 1 wherein the handle includes a mechanism biasing the trigger out of the engaged position.

3. The marine winch of claim 2 wherein the handle locking pawl is coupled to a pivot pin on the handle body for rotation on the handle body into and out of engagement with the ratchet gear.

4. The marine winch of claim 3 wherein when the trigger is in the engaged position, the handle locking pawl is configured to rotationally secure the handle body to the ratchet gear and the drum in one rotational direction and allow ratcheting of the pawl and the ratchet gear in an opposite relative rotational direction.

5. The marine winch of claim 4 further including a pawl biasing member coupled to the handle locking pawl biasing the pawl in one direction.

6. The marine winch of claim 5 further including linkage arm extending between the trigger mechanism and the handle locking pawl.

7. The marine winch of claim 6 wherein the trigger mechanism is coupled to a pivot pin on the handle end grip of the handle body for rotation on the handle body into and out of the engaged position.

8. The marine winch of claim 7 wherein the handle body includes two spaced side plates extending to the handle end grip.

9. The marine winch of claim 8 wherein the pawl biasing member is a spring extending between the pawl and the linkage arm.

10. The marine winch of claim 9 wherein the mechanism biasing the trigger out of the engaged position is a torsion spring mounted to the end grip.

11. A self-releasing handle for a manual marine winch for selectively tensioning a drum of the winch, the handle including
i) a ratchet gear coupled to the drum wherein rotation of the ratchet gear will cause rotation of the drum of the marine winch,
ii) a rotating handle body with a manual end grip,
iii) a user engaged trigger mechanism on the end grip moveable between an engaged position and a release position, and
iv) a handle locking pawl on the handle body and coupled to the trigger mechanism and moveable between a position engaged with the ratchet gear rotationally securing the handle body to the ratchet gear and the drum in at least one direction when the trigger is in the engaged position and a position disengaged with the ratchet gear rotationally separating the handle body from the ratchet gear and the drum when the trigger is not in the engaged position.

12. The self-releasing handle of claim 11 wherein the handle includes a mechanism biasing the trigger out of the engaged position.

13. The self-releasing handle of claim 2 wherein the handle locking pawl is coupled to a pivot pin on the handle body for rotation on the handle body into and out of engagement with the ratchet gear.

14. The self-releasing handle of claim 3 wherein when the trigger is in the engaged position, the handle locking pawl is configured to rotationally secure the handle body to the ratchet gear and the drum in one rotational direction and allow ratcheting of the pawl and the ratchet gear in an opposite relative rotational direction.

15. The self-releasing handle of claim 14 further including a pawl biasing member coupled to the handle locking pawl biasing the pawl in one direction.

16. The self-releasing handle of claim 15 further including linkage arm extending between the trigger mechanism and the handle locking pawl.

17. The self-releasing handle of claim 16 wherein the trigger mechanism is coupled to a pivot pin on the handle end grip of the handle body for rotation on the handle body into and out of the engaged position.

18. The self-releasing handle of claim 17 wherein the handle body includes two spaced side plates extending to the handle end grip.

19. The self-releasing handle of claim 8 wherein the pawl biasing member is a spring extending between the pawl and the linkage arm.

20. The self-releasing handle of claim 19 wherein the mechanism biasing the trigger out of the engaged position is a torsion spring mounted to the end grip.
